(19) United States
(12) Patent Application Publication
(10) Pub. No.: US 2026/0186293 A1
(43) Pub. Date: Jul. 2, 2026

(54) METHOD AND APPARATUS FOR AGILE LIGHT PATH STEERING

(71) Applicant: Lacy Cook, El Segundo, CA (US)

(72) Inventor: Lacy Cook, El Segundo, CA (US)

(73) Assignee: NewBridge Partners, Inc., Herndon, VA (US)

(21) Appl. No.: 19/001,673

(22) Filed: Dec. 26, 2024

(51) Int. Cl. G02B 26/08

(52) U.S. Cl. CPC G02B 26/0808; G02B 26/0883

(57) ABSTRACT

An optical system includes a light transceiver having a steering axis where a light transceiver transmits and/or receives a first light beam along an external light path. The optical system having a first beam-deviation optical element, which controls the external light path, and includes a first prism having a first diffraction grating in the first order and the steering axis passes through the first beam-deviation optical element. The optical system having a second beam-deviation optical element, which also controls the external light path, and includes a second prism having a second prism structure and a second diffraction grating in the first order, where the steering axis passes through the second beam-deviation optical element. The optical system further includes a rotational drive assembly operable to provide rotation of the first beam-deviation optical element and the second beam-deviation optical element where the rotation adjusts the angle of the external light path.

### BACKGROUND OF THE DISCLOSURE

The disclosure relates to optical systems, and in particular, systems for steering a light path along which a light beam travels.

Optical devices are known which can steer a light path along which a light beam travels. A known optical device can include a light transceiver and one or more beam deviation optical elements. The light transceiver can send and/or receive a light beam.

The optical device with light transceiver can be pointed in a specific direction using the beam deviation elements. Based on such pointing of the optical device, the direction of the light path can be selected along which the light beam is transmitted and/or received. A light transceiver may include both a light transmitter and a light receiver.

The light transceiver and one or more beam deviation optical elements can be mechanically supported and/or otherwise provided on a support such that the light transceiver can be directed in a desired direction. If the light transceiver is a light transmitter, the outgoing light beam can be pointed or steered in the selected direction so as to transmit the light beam. In the situation that the light transceiver is a light receiver, the light receiver can be pointed to the angle of an incoming light beam. Accordingly, the pointing of the optical device can be provided by a suitable mechanical support system. For example, such a suitable mechanical support system can be a gimbal. While a conventional gimbal can be useful in certain applications, gimbals are known to be large, heavy, and require considerable electrical power for operation.

The steering of a light beam by the operation of two or more Risley prisms is a known technique. Among known features are: a) the functional results and attendant control laws that govern the motion of one prism with respect to others, and the coordinated motion of pairs of prisms, b) The hardware, electronics, and software needed to implement the various motions, c) the need to control the transmitter lead ahead angle (resulting from the finite speed of light) if the range involved is large. While the use of two or more Risley prisms offers a considerable reduction in size, weight, and power over that of a gimbal, there are still limitations to their operation that require a solution. A known limitation of Risley prisms that critically restricts the angular extent of the steering and the wavelength width of the spectral band that can be utilized is the result of the wavelength dispersion (variation in refractive index) of the prisms involved. Additionally, it is known that for multiple-radian steering angles and spectral bands as wide as 100 nm (nanometer), the classical approaches to achromatizing the prisms using a second more dispersive (flint) prism material have been proven to be impractical. This impracticality stems from the fact that relevant refractive materials lack a sufficient dispersion difference to provide such achromatization.

Thus, there exists a need for a compact low power steering device capable of multi-radian steering angles and wavelength bands approaching 100 nm (nanometer).

The systems and methods of this disclosure address these limitations, as described below.

### BRIEF SUMMARY OF THE DISCLOSURE

The present invention provides an optical system comprising: a light transceiver having a steering axis associated with such light transceiver, wherein the light transceiver transmits and/or receives a first light beam along an external light path; a first beam-deviation optical element, which controls the external light path, including a first prism having a first diffraction grating thereon, and wherein the steering axis passes through the first beam-deviation optical element, the first prism and the first diffraction grating collectively providing a first grism, the first prism diffraction grating having a diffraction order in the first order ; and a second beam-deviation optical element, which also controls the external light path, including a second prism structure having a second diffraction grating thereon, wherein the steering axis passes through the second beam-deviation optical element, the second prism and the second diffraction grating collectively providing a second grism; the second prism diffraction grating also having a diffraction order in the first order; and a rotational drive assembly operable to provide rotation to at least one of the first beam-deviation optical element and the second beam-deviation optical element about the steering axis, and the rotation adjusting an angle of the external light path as compared with the steering axis.

The optical system of the present invention is ideally suited where the first light beam is within the 30-60 nm wavelength range. The optical system of the present invention is ideally suited where the first prism has a prism apex angle of 6.0 degrees +/−3.0 degrees; and the first grating has a grating apex angle of 0.5 degrees +/−0.3 degrees. Additionally, the optical system of the present invention is ideally suited where the first prism has a prism apex angle of 6.3 degrees +/−0.5 degrees; and the first grating has a grating apex angle of 0.47 degrees +/−0.1 degrees. The first grism and the second grism of the optical system of the present invention could be constructed of GaAs (Gallium Arsenide). The first grism and the second grism could have substantially the same construct, such that the first grism and the second grism are interchangeable.

Further, the optical system of the present invention could have the first beam-deviation optical element positioned between the second beam-deviation optical element and the light transceiver, OR the second beam-deviation optical element is positioned between the first beam-deviation optical element and the light transceiver. The optical system could have the first prism possessing a prism apex angle of 6.0 degrees +/−2 degrees; and the first grating possessing a grating apex angle of 0.5 degrees +/−0.2 degrees. The first diffraction grating is ideally positioned on a side of the first prism that opposes the light transceiver; the second diffraction grating is ideally positioned on a side of the second prism that opposes the light transceiver; and the first grism including a first crystal, and the second grism including a second crystal. Further, the optical system of the present invention can be designed where the first grism includes a plurality of facets, each of the facets having a facet width of 80 um (micrometers) +/−10 um; and each of the facets having a facet depth of 0.7 um (micrometers) +/−0.1 um. The optical system of the present invention further providing a broad spectral range of 30-90 nm (nanometers) in conjunction with providing an angular deviation, for the external light path, of 0 to 1 radian (0 to 57.2 degrees).

The optical system of the present invention, further including a frame assembly, the frame assembly supporting the light transceiver, the first beam-deviation optical element, the second beam-deviation optical element, and the rotational drive assembly; and the frame assembly being supported by a base assembly, the base assembly include a 3-D rotator mechanism that is configured to adjust the angle and direction of the light transceiver, so as to adjust the angle and direction of the steering axis of the optical system. The optical system of the present invention where the light transceiver is configured to transmit the first light beam, and the light transceiver is configured to receive a second light beam. Further, the rotational drive assembly includes: a first support rotator to support the first beam-deviation optical element; and a second support rotator to support the second beam-deviation optical element. The rotational drive assembly could also include a third support rotator that supports the first beam-deviation optical element and the second beam-deviation optical element.

### BRIEF DESCRIPTION OF THE DRAWINGS

The present disclosure can be more fully understood by reading the following detailed description together with the accompanying drawings, in which like reference indicators are used to designate like or similar elements, and in which:

FIG. 1 is a schematic side view of a grism-frame assembly, in accordance with principles of the disclosure.

FIG. 2 is a schematic side view of a portion of the grism of FIG. 1, showing additional detail, in accordance with principles of the disclosure.

FIG. 3 is a schematic diagram of an optical system 10, in accordance with principles of the disclosure.

FIG. 4 is a further schematic side view of a grism-frame assembly the same as or similar to that of FIG. 1, in accordance with principles of the disclosure.

FIG. 5 is a schematic top view of a grism-frame assembly the same as or similar to that shown in FIG. 4, in accordance with principles of the disclosure.

FIG. 6 is a schematic side view of an inner grism-frame assembly the same as or similar to that shown in FIG. 3, in accordance with principles of the disclosure.

FIG. 7 is a schematic top view of an inner grism-grating assembly the same as or similar to that shown in FIG. 3 and/or FIG. 6, in accordance with principles of the disclosure.

FIG. 8 is a diagram showing a first system arrangement, in accordance with principles of the disclosure.

FIG. 9 is a diagram showing a second system arrangement, in accordance with principles of the disclosure.

FIG. 10 is a diagram showing a third system arrangement, in accordance with principles of the disclosure.

FIG. 11 is a diagram showing a fourth system arrangement, in accordance with principles of the disclosure.

FIG. 12 is cross-section schematic view of an outer support rotator the same as or similar to such shown in FIG. 3, in accordance with principles of the disclosure.

FIG. 13 is a top schematic view of the outer support rotator the same as or similar to such shown in FIG. 12, in accordance with principles of the disclosure.

FIG. 14 is a cross-section schematic view of an inner support rotator the same as or similar to such shown in FIG. 3, in accordance with principles of the disclosure.

FIG. 15 is a top schematic view of an inner support rotator the same as or similar to such shown in FIG. 14, in accordance with principles of the disclosure.

FIG. 16 is a cross-section schematic view of an outboard support rotator the same as or similar to such shown in FIG. 3, in accordance with principles of the disclosure.

FIG. 17 is a top schematic view of an outboard support rotator the same as or similar to such shown in FIG. 16, in accordance with principles of the disclosure.

FIG. 18 is a schematic diagram of a two-part grism, in accordance with principles of the disclosure.

### DETAILED DESCRIPTION OF THE DISCLOSURE

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

As used herein, any term in the singular may be interpreted to be in the plural, and alternatively, any term in the plural may be interpreted to be in the singular.

The disclosure provides an optical system for steering a light path along which a light beam travels. The system of the disclosure can provide a novel low SWaP (size, weight, and power) apparatus for steering a broad spectrum of laser beams over a very wide field of view (FOV). The optical system of the disclosure can include a pair of prism-grating assemblies, i.e. “grisms” that rotate with respect to each other and/or that rotate with each other. The broad spectral coverage can result from cancellation of the prism material dispersion with the diffraction dispersion of the grating.

It is known in the art to steer light beams. For example, light beams can be steered by the rotation of two or more “Risley” prisms. However, the wavelength bandwidth (wavelength interval involved), using known technology, is typically limited by material dispersion that occurs within the prisms. That is, the presence of refractive index variations in combination with wavelengths of light can limit the wavelength bandwidth that can be used within known Risley prisms.

For example, U.S. Pat. No. 7,813,644 (the “644 Patent”) is directed to an optical device that provides the ability to steer a light path. In particular, such patent describes a steerable-light-path optical device that includes a light transceiver having an external light path associated therewith, and a path-steering device that controls the direction of the light path relative to a steering axis.

Importantly, the '644 Patent is directed to a system which simultaneously steers a narrow shorter wavelength laser line and a broader longer wavelength passive imaging band to the same angle. For this to efficiently occur, the grating equation teaches that the product of the wavelength multiplied by the grating operating diffraction order must be the same for both the shorter wavelength laser line and the near-midpoint of the broader longer wavelength passive imaging band. This is exemplified for all detailed embodiments described in the '644 Patent which provides examples of: (i) a 1.55 um (micrometer) wavelength line operating in the third order and the 3-5 um (micrometer) passive band operating in the first order; the product being 4.65 um (micrometer); and (ii) a 1.55 um line operating in the sixth order and the 8-10 um (micrometer) passive band operating in the first order; the product being 9.3 um (micrometer).

It can be appreciated that the structure and functionality of '644 Patent limits the practical steering angles and spectral bandwidths of both the shorter and longer wavelengths due to wavelength dispersion because of the high operating diffraction order of the shorter wavelength and the broad spectral coverage of the longer wavelength. Indeed, differentiation of the simple grating equation m*lambda=d*sin(theta) results in an expression of the angular error of (delta theta)=[m*(delta lambda)]/[d*cos(theta)]. Thus, in a practical sense: high diffraction orders, broad wavelength bands, and large deviation angles all contribute to large angular errors at both wavelengths.

However, the device of the '644 is unsuitable for some purposes. For example, the device of the '644 Patent is limited because the laser wavelength involved therein is very narrow and severely limited (for example, to about 5 nm (nanometers) because the laser wavelength operates at a much higher diffraction order and would not be able to extend to laser bandwidths in the regime of 30-60 nm as it would involve an unacceptable angular spread (with LOS (line of sight) or boresight errors) between channels.

Therefore, there is a need for a steering method and apparatus which can cover broader wavelength bands over larger angular deviations with single digit micro-radian angular accuracy.

The systems and methods of the present invention and disclosure provides various novel and unique attributes that address such limitations.

The material dispersion (and therefore wavelength dependent angular error) of each prism/grism of the present invention, as described in detail below, can be canceled over large angles and for wide wavelength bands using a long period (very weak) grating operating in the first diffraction order. Importantly, each grism of the present invention is in the first diffraction order.

This dispersion cancellation (also known as color correction) over large angles and wide wavelength bands is impractical using a second opposing prism of a different and more dispersive material because the dispersion difference is not very large.

The system of the disclosure can provide a grating that has much more diffraction dispersion than the material dispersion of known prisms, so as to provide dispersion correction. In such dispersion correction, the angular deviations of the prism and grating add, while the dispersion cancels. For example, in accordance with embodiments of the disclosure:
For a GaAs (Gallium Arsenide) prism, which can be in the form of a crystal, with a total of 17.5 degree deviation, the prism produces about 93% of the angular deviation, while the grating produces about 7%; (with grating period of about 84 um (micrometers, i.e. microns).
For a Si prism with a total of 17.5 deg deviation, the prism produces about 95% of the angular deviation, while the grating produces about 5%; (with a grating period of about 110 um).

Further, the dispersion cancellation is only limited by classical secondary color (the angular error at the center wavelength).

In accordance with embodiments of the disclosure, for a GaAs grism pair, for all grism orientations from full subtraction (0 degs) to full addition (35 degrees), for example, the resulting maximum angular error due to secondary color for a given wavelength band is proportional to the square of that wavelength band. For example:
30 nm bandwidth, the max error is around 0.8 urads (microradians), i.e. with a microradian being one millionth of a radian;
40 nm bandwidth, the max error is around 1.4 urads;
50 nm bandwidth, the max error is around 2.2 urads; and
60 nm bandwidth, the max error is around 3.2 urads.

In accordance with embodiments of the disclosure, for a 10 cm aperture beam at 1.55 um (micrometer) wavelength, the above 3.2 urad maximum line of sight error is only about 10% of the total beam angular spread due to diffraction and small phase errors, which often totals 25-30 urads. Such is a relevant angular performance reference. It is generally desired that the total angular variation within the bandwidth of interest be a small fraction of the inherent angular spread of the transmitted beam.

Further, it is noted that in a laser communications system, many individual wavelength channels can be multiplexed (and de-multiplexed) within a 30-60 nm wavelength capability. The practical channel separation is only limited by the channel-to-channel crosstalk considerations. Thus, the total information capacity of the data link can be greatly increased. For example, within a 30 nm bandwidth, there can be about 6-7 separate wavelengths if the chosen separation is 5 nm.

In the systems and methods of the disclosure, maximum grating diffraction efficiency can be achieved using ruled grating facets with sharp corners that geometrically operate like small prisms. Other known grating fabrication techniques generally produce much lower diffraction efficiencies. For example, such other fabrication techniques might involve a holographically recorded grating processed by ion or e-beam etching. Further details are described below.

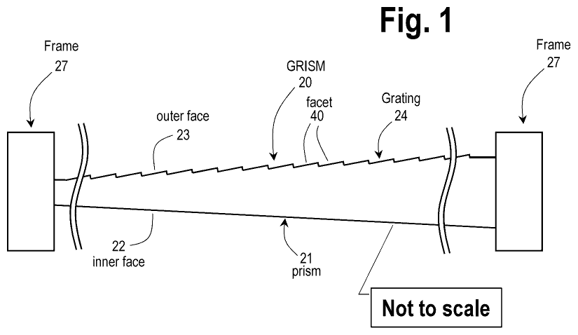

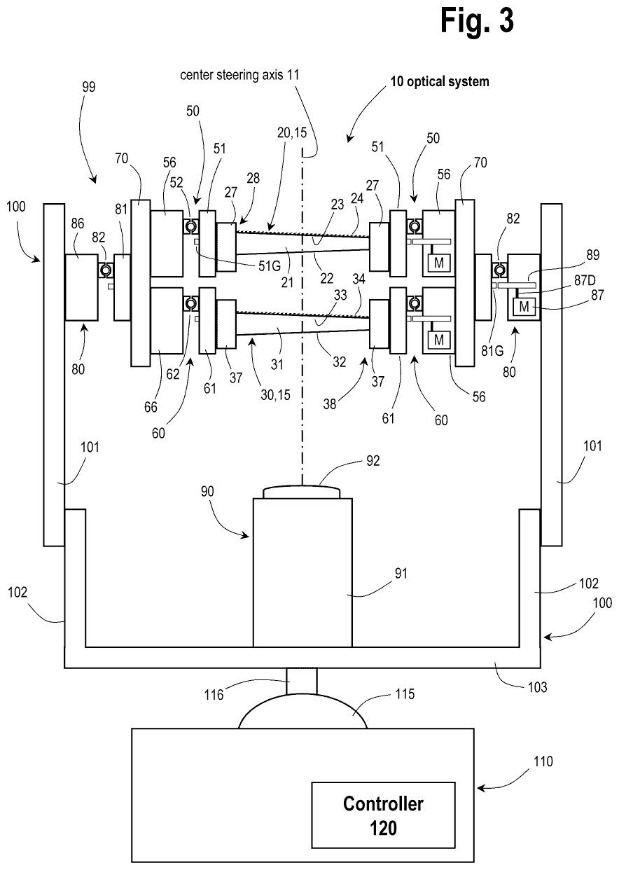

FIG. 1 is a schematic side view of a grism 20, in accordance with one or more embodiments of the disclosure. The grism 20 can include a prism 21 and a grating 24, as described further below. The grism 20 can include opposing surfaces or faces. The opposing faces or sides can include an inner face 22 and an outer face 23. As shown in FIG. 3, described below, the inner face 22 can be closest to a light transceiver assembly 90, as compared with the outer face 23. That is, the inner face 22 can be on a side of grism 20 that faces the light transceiver assembly 90. The outer face 23 can be on a side of grism 20 that opposes the light transceiver assembly 90. The inner face 22 and the outer face 23 can be angled relative to each other, so as to provide the prism 21, of the grism 20. For example, the grism 20 of FIG. 1 can be an “outer grism” of an optical system or optical assembly 10, as described in detail below.

The grism 20 can be provided with, i.e. include, a prism 21 and grating layer 24. That is, the outer face 23 can be provided with a grating layer or a grating 24. In that the prism 21 includes, is integrated with, and/or attached to the grating 24. The prism 21 with grating layer 24 can be described as “grism” 20. The grating 24 can be provided to deflect light, i.e. to further deflect light, passing through the grism 20, as is further described below. In accordance with the embodiment shown in FIG. 1 and as further shown in FIG. 5, the grism 20, can be circular in shape from the perspective of a top view of the outer grism 20. However, the grism 20 may be constructed in other shapes, such as oval, rectangular, square, or any other shape as desired.

As shown in FIGS. 1 and 3, the grism 20, which can provide or be an “outer grism” 20, can be rotatably supported by a grism-frame 27. The grism-frame 27 can be annular in shape, circular

in shape, or any other desired shape so as to surround, mate with, and support the outer grism 20. Accordingly, the grism-frame 27 can be the same shape as the outer grism 20, i.e. the same shape as the prism 21, so as to surround and engage the grism 20. The frame 27 can be any shape as desired so as to be compatible with the shape of the outer grism 20 and support the outer grism 20.

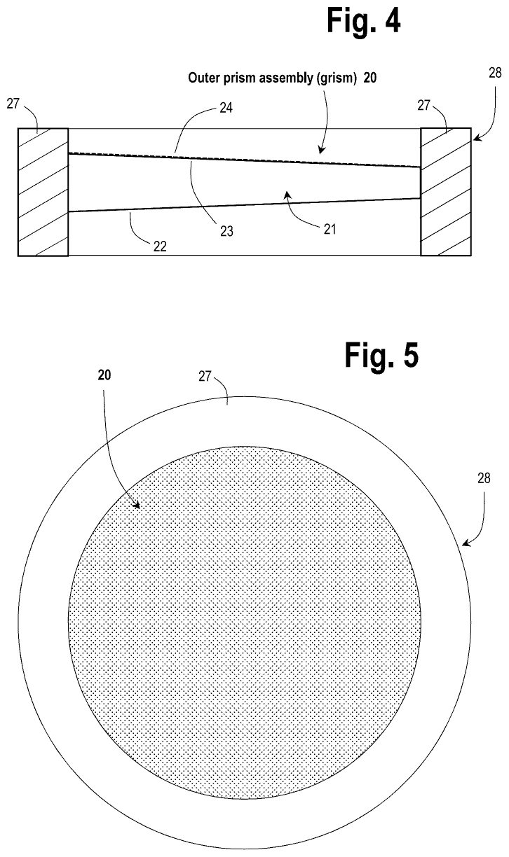

Relatedly, FIG. 4 is a schematic side view of an outer prism-grating assembly the same as or similar to that shown in FIG. 1, in accordance with principles of the disclosure. FIG. 5 is a schematic top view of an outer prism-grating assembly the same as or similar to that shown in FIG. 4, in accordance with principles of the disclosure.

The outer grism 20 in combination with the grism-frame 27 can be described as a grism-frame assembly 28. More specifically, the outer grism 20 in combination with the frame 27 can be described as an outer grism-frame assembly 28.

The optical system 10, as shown in FIG. 3, can also include an inner grism 30. The inner grism 30 can be similar or same in structure as the outer grism 20.

The outer grism 20 can be described as a first beam-deviation element 20. The inner grism 30 can be described as a second beam-deviation element 30.

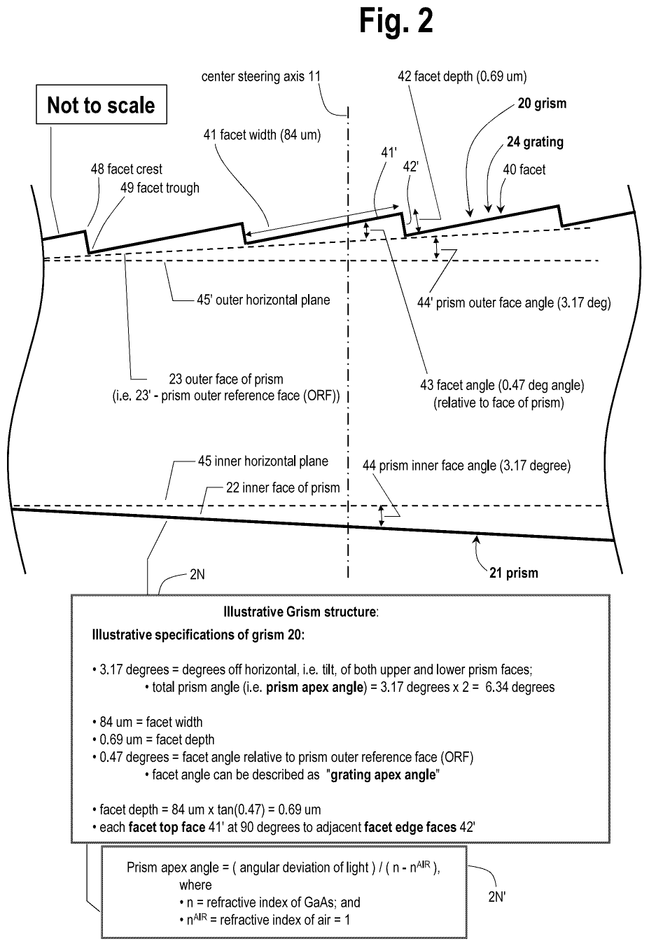

Hereinafter, further details of the outer grism 20 will be described with reference to FIG. 2. FIG. 2 is a schematic diagram of a portion of the outer grism 20 of FIG. 1, in accordance with one or more embodiments of the disclosure. It is appreciated that the grism shown in FIG. 2 is not to scale, nor are other diagrams described herein to scale, in that size of the grism described herein is on the scale of nanometers. Accordingly, rather than the approximately 16 “facets” that the grism of FIG. 1 is shown to include, such grism may include 100s or 1000s of facets, depending on the size of the grism and the period of the grating.

As shown in FIG. 2, as well as in FIG. 3, the grism 20 is aligned with a center steering axis 11, i.e. steering axis 11. As shown in FIG. 2, the grism 20 may include an inner prism face 22 (i.e. an inner face 22) and an outer prism face 23 (i.e. an outer face 23). In the example of FIG. 2, both the inner face 22 and the outer face 23 can be positioned in respective planes that are “off horizontal”, i.e. at an angle to horizontal. In this example, and assuming that the grism 20 is aligned with a center steering axis 11 that is vertical (see FIG. 3), the inner face 22 can be 3.17 degrees (deg) off horizontal, i.e. off an inner horizontal plane 45. The outer face 23 can also be 3.17 deg off horizontal, i.e., off an outer horizontal plane 45′. In other words, a prism inner face angle 44 (see FIG. 2) can be 3.17 degrees; and a prism outer face angle 44′ (see FIG. 2) can also be 3.17 degrees, in accordance with one or more embodiments of the disclosure.

Accordingly, in some embodiments of the disclosure, both prism faces can be the same or similar angle off horizontal, with “horizontal” being understood to be 90 degrees off the steering axis 11 of the optical system, when the steering axis 11 is aligned with a vertical axis. Such disposition is illustratively shown in FIG. 2, for example. In operation of the optical system, the steering axis 11 will be adjusted to various angles as needed, so as to steer a light beam as needed.

However, in some embodiments of the disclosure, one face of a prism might be angled relative to horizontal, i.e. when the center steering axis is positioned along a vertical axis, while the other face of such prism might be at a different angel as compared to horizontal and/or may be aligned with horizontal. Accordingly, in general, it is appreciated that both faces of a prism need not be angled the same amount relative to horizontal, when the center steering axis 11 is aligned with a vertical axis.

As described above and shown in FIG. 2, the grism 20 can include a grating 24. The grating 24 can be a part of the grism 20, which is basis for calling the grism 20: a “grism” 20. The grating 24 can include facets 40. Each of the facets 40 can possess a facet width 41 and a facet depth 42. For example, the facet width can be 84 um (i.e. 84 microns or 84 micrometers). A micron is 1/1000 of a millimeter. For purposes of comparison, a human hair can have a diameter of about 70 microns. With further reference to FIG. 2, for example, the facet depth can be 0.69 um.

As shown in FIG. 2, each of the facets 40 can include a facet crest 48 and a facet trough 49. In accordance with one interpretation, the grism 20 can be described as including a “prism outer reference face” 23′, i.e. a prism ORF 23′. The prism ORF 23′ can be defined as positioned in or defined by a plane that passes through the facet troughs 49. Such interpretation is illustrated in FIG. 2. Accordingly, the prism ORF 23′ can be understood to constitute the outer face 23 of the prism/grism 20. Accordingly, in accordance with one embodiment of the disclosure, it is the prism ORF 23′ that is off horizontal by 3.17 degrees, i.e. that has a “tilt” or prism outer face angle 44′ (see FIG. 2) of 3.17 degrees. Further, the “grating” 24 can be interpreted or described as being the material (of the grism 20) that lies outside, i.e. above in FIG. 2, the prism ORF 23′.

It is appreciated that under another interpretation, the outer face 23 of the prism 21 can be constituted by the collection of the facet widths 41 and the facet depths 42.

Further, the facet width 41 can be described as a facet top face 41′ or top face 41′. The facet depth 42 can be described as a facet edge face 42′ or edge face 42′.

The facets 40 can be formed, on the prism, in manufacture by an etching or scribing process, for example. As noted above, in the systems and methods of the disclosure, maximum grating diffraction efficiency can be achieved using ruled grating facets with sharp corners that geometrically operate like small prisms.

The facet top face 41′ (of a facet) can be oriented at right angle (90 deg) relative to a respective adjacent “facet edge face” 42′ on both sides of the facet top face 41′. That is, a top face 41′ (on a first side thereof) can be adjacent a first edge face 42′ at a trough 49 (of the particular facet); and such top face 41′ (on a second side thereof) can be adjacent a second edge face 42′ at a crest 48 (of such facet).

As shown in FIG. 2, the facet top face 41′, i.e. the facet width 41, can be positioned at a predetermined angle relative to the prism ORF 23′. In the illustrative example of FIG. 2, the facet top face 41′ can be positioned at an angle of 0.47 degrees relative to the prism ORF 23′. That is, a “facet angle” 43, as shown in FIG. 2 can be 0.47 degrees, in accordance with at least one embodiment of the disclosure.

In accordance with aspects of the disclosure, generally, the higher the material dispersion of the prism and the higher the prism apex angle (i.e. the higher the prism outer reference face (ORF) 23′as shown in FIG. 2), the grating period must decrease, producing a more “powerful” grating, i.e. powerful in such grating's ability to deflect a beam of light and thus cancel the material dispersion.

Accordingly, as shown in FIG. 2 at 2N, a grism structure can possess illustrative specifications or attributes. Such illustrative specifications or attributes, in accordance with at least one embodiment of the disclosure, can include for example, for a GaAs (Gallium Arsenide) crystal prism material:
3.17 degrees=degrees off horizontal, i.e. tilt, of upper and lower prism faces; and such upper prism face can be described as prism outer reference face (ORF)—see FIG. 2;
total prism angle (i.e. prism apex angle)=3.17 degrees×2=6.34 degrees;
84 um=facet width of each facet 40 of grism 20;
0.69 um=facet depth of each facet 40 of grism 20;
0.47 degrees=facet angle off upper prism face, i.e. angle of facet outer face relative to prism

outer reference face (ORF);
facet depth=84 um×tan (0.47 degrees)=0.69 um;
each facet top face 41′ can be at 90 degrees to adjacent facet edge faces 42′.

The refractive index (N) for GaAs (Gallium Arsenide) crystal, for example, can vary depending on wavelength of light passing through such crystal. For example, a GaAs crystal can have refractive index (N)=3.370.

As shown at 2N′ in FIG. 2, for thin prisms, a known relationship is:

(Prism apex angle)=(angular deviation of light)/(n−n^{AIR}),

where
n=refractive index of GaAs; and
n^{AIR}=refractive index of air=1

Or, in re-arranging such equation:

(Angular deviation of light)=(Prism apex angle)×(n−n^{AIR})

In accordance with one illustrative example, using an approximation, based on the arrangement with the specifications, i.e. “specs” described above:

The approximation is used because the prism apex angle is small, and the prism is used in minimum deviation geometry.
Angular deviation of light from prism=(6.34 degrees)×(3.37−1)=15.02 degrees
Angular deviation of light from grating=(0.47 degrees)×(3.37−1)=1.11 degrees

Accordingly, the total angular deviation for the grism 20, as shown in FIG. 2, can be:
Angular deviation from prism+Angular deviation of light from grating =15.02 degrees+1.11 degrees=16.13 degrees

Accordingly, light passing through the grism 20, in accordance with this example will be bent 16.13 degrees.

In further explanation of aspects of the disclosure, in the context of a prism constructed of a particular material the “refractive index” of the prism can refer to the material's ability to bend light. The materials refractive index can be denoted by “n”. A prism's “apex angle” is the angle at which the two surfaces of the prism are positioned, i.e. the angle at the pointed end of the prism, which can be represented by the symbol “α”. The value “n−1” can represent the difference between the refractive index of the prism material and the refractive index of air. The refractive index of air is usually considered as “1”, which can be used as a factor in calculating the angle of deviation of light passing through the material of the prism.

Accordingly, the refractive index (n) is a value that indicates how much light bends when entering the material of the prism from another medium, such as air, and then exiting the material of the prism back into the another medium, i.e. back into air. Accordingly, when light, i.e. a ray of light, passes through the prism, the amount of angular deviation (i.e. the amount of bending) is directly related to the refractive index of the material from which the prism is constructed, as well as directly related to the apex angle of the prism. Relatedly, for prism have small apex angles (i.e. for thin prisms) the angular deviation (i.e. how much a ray of light is bent) is approximately equal to (n−1)×(α), where “α” is the prism's apex angle, as noted above. Based on such relationship, it should of course be appreciated that, as a difference between the refractive index (of the material of the prism) and air gets larger, such results in the angular deviation getting larger, i.e. results in greater light bending.

For example, a range of known refractive index values for GaAs can be from about 3.370 to about 3.399, based in known literature. In accordance with one aspect of the disclosure, it is appreciated that small adjustments may need to be made in grating parameters based on the specific refractive index encountered in the particular material being used, e.g., in the particular GaAs material being used.

Various particular specifications are described herein for purposes of illustration. However, it is appreciated that the disclosure of the invention is not limited to such particulars. For example, in addition to the other examples described herein, a grism 20 and/or grism 30 of the disclosure can be constructed with different specifications, such as for example:
prism apex angle of 6.0 degrees +/−3.0 degrees;
prism apex angle of 6.0 degrees +/−2.0 degrees;
prism apex angle of 6.0 degrees +/−1.0 degrees;
grating possessing a grating apex angle of 0.5 degrees +/−0.3 degrees;
grating possessing a grating apex angle of 0.5 degrees +/−0.2 degrees;
grating possessing a grating apex angle of 0.5 degrees +/−0.1 degrees;
each of the facets can possess a facet width of 80 um (micrometers) +/−20 um;
each of the facets can possess a facet width of 80 um (micrometers) +/−10 um;
each of the facets can possess a facet width of 80 um (micrometers) +/−5 um;
each of the facets can possess a facet depth of 0.7 um (micrometers) +/−0.2 um;
each of the facets can possess a facet depth of 0.7 um (micrometers) +/−0.1 um;
each of the facets can possess a facet depth of 0.7 um (micrometers) +/−0.05 um.

As used above, the indicia “+/−” means “plus or minus”.

Accordingly, with the illustrative example of FIG. 2, such grism can provide, upon rigorous raytracing, particular deviation properties. For example, the grism of FIG. 2 can provide a prism deviation of 15.34 deg (i.e. degrees); a grating deviation of 1.11 deg; and a total grism deviation of 16.45 deg. Accordingly, the prism without the grating is 93% of the deviation, and the grating is 7% of the deviation of a light beam passing through the grism.

It is appreciated that it may be beneficial to provide anti-reflection coating on both grism faces. Such anti-reflection coatings are known and can be specifically designed for the particular wavelength band being used. For example, anti-reflection multi-layer dielectric coating for high index optical and IR materials may be used on the prism(s) as described herein.

The grism 20 of FIGS. 1 and 2 can be used in various optical systems. In accordance with one embodiment of the disclosure, FIG. 3 is a schematic diagram of an optical system 10. The system 10 can include light transceiver assembly 90 and a grism-grating pair 15. The grism-grating pair 15 can include the grism 20 and the grism 30, i.e. the outer grism 20 and the inner grism 30, as shown in FIG. 3. The light transceiver assembly 90 (see FIG. 3, for example) can be a light transmitter and/or a light receiver, collectively described herein as a light transceiver. As described above, the grisms of the optical system 10 can include an outer grism 20 or outer grism 20; and an inner grism 30 or inner grism 30. Accordingly, the grism of FIGS. 1 and 2 can be used in the optical system 10 of FIG. 3. Further details of the optical system 10 are described below.

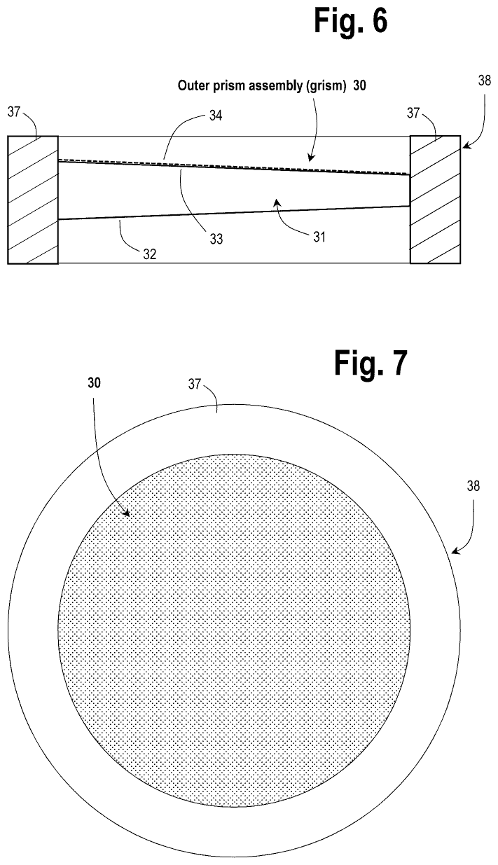

FIG. 6 is a schematic side view of the inner grism 30. The inner grism 30 can be similar or the same as the outer grism 20; or can be different from the construct of the outer grism 20. FIG. 7 is a schematic top view of the inner grism 30. The inner grism 30 can include a prism 31 with opposing surfaces. The opposing surfaces can include an inner face or surface 32 and an outer face or surface 33. As shown in FIG. 3, the inner face 32 is closest to the light transceiver assembly 90, as compared with the outer face 33. As with the grism 20 described above, the inner face 32 and the outer face 33 can be angled relative to each other, so as to provide the prism 31.

The inner grism 30 can also be provided with a grating layer 34. That is, the outer face 33 can be provided with a grating layer 34. The grating layer 34 can be provided to further deflect light passing through the prism 31. In accordance with the embodiment shown in FIG. 7, the grism 30, i.e. the inner grism 30, can be circular in shape from the perspective of a top view of the inner

grism 30 (as shown in FIG. 7). However, the inner grism 30 may be constructed in other shapes, such as oval, rectangular, square, or any other shape as desired.

As shown in FIG. 3 and FIG. 6, the inner grism 30 can be rotatably supported by a grism-frame 37. The grism-frame 37 can be annular in shape, circular in shape, or any other desired shape so as to surround and support the inner grism 30. The grism-frame 37 can be the same shape as the inner grism 30, so as to surround and engage the inner grism 30. The frame 37 can be any shape as desired so as to be compatible with the shape of the inner grism 30 and support the inner grism 30.

The inner grism 30 in combination with the grism-frame 37 can be described as a grism-frame assembly 38. More specifically, the inner grism 30 in combination with the frame 37 can be described as an inner grism-frame assembly 38.

As shown in FIG. 3, the outer grism 20 and the inner grism 30 can be aligned with each other and positioned about a center steering axis 11 or steering axis 11. Relatedly, the light transceiver assembly 90, as shown in FIG. 3, can be aligned with the steering axis 11 so as to emit light along the center steering axis 11 and/or so as to be able to receive light along the steering axis 11. The light transceiver assembly 90 can include a light transceiver 91. The light transceiver 91 may include a light transmitter and/or a light receiver, as otherwise described herein. The light transceiver assembly 90 can include a lens 92.

In operation of the optical system 10, the outer grism 20 and the inner grism 30 can be rotated relative to each other so as to steer a path of light, as described herein. That is, the outer grism 20 and the inner grism 30 can have “independent rotation” relative to each other so as to steer light at varying angles. Further, the outer grism 20 and the inner grism 30 can be rotated together, i.e. the outer grism 20 and the inner grism 30 can be rotated as a unit, so as to steer a path of light in a desired direction. Such rotation of the outer grism 20 and the inner grism 30, as a unit, can be described as “unit rotation”. During such unit rotation, the outer grism 20 and the inner grism 30 can be locked together, i.e. so as to rotate as a unit.

To explain in further detail, independent rotation of the outer grism 20 and the inner grism 30 can control the angle of the light beam path relative to the center steering axis 11. Relatedly, the outer grism 20 and the inner grism 30 may possess a respective angle of deflection due the physical structure of the outer grism 20 and the inner grism 30.

For example, the outer grism 20 can provide a total deflection angle of 16.45 degrees. Such deflection angle is generated by both the prism 21 itself and the grating 24 of the prism 21. In similar manner, the inner grism 30 can also provide a total deflection angle of 16.45 degrees. Such deflection angle is generated by both the prism 31 itself and the grating 34 of the prism. The grism combination will then produce a total beam deviation of about 35 degrees, and hence a total cone angle of deviation measuring 70 degrees.

The outer grism 20 and/or the outer grism-frame assembly 28 can be described as a first beam-deviation optical element. The inner grism 30 and/or the inner grism-frame assembly 38 can be described as a second beam-deviation optical element.

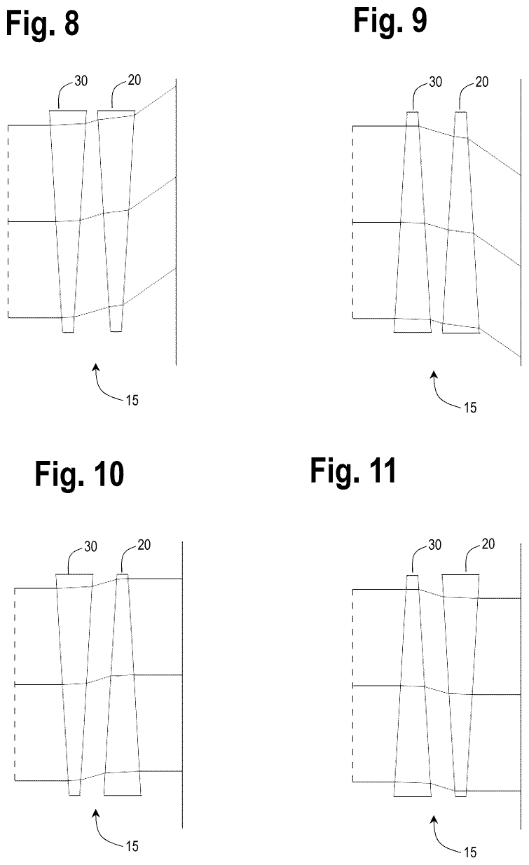

FIGS. 8-11 show different operational arrangements of an optical system 10, in accordance with principles of the disclosure.

In particular, FIG. 8 is a diagram showing a first system arrangement. FIG. 9 is a diagram showing a second system arrangement. FIG. 10 is a diagram showing a third system arrangement. FIG. 11 is a diagram showing a fourth system arrangement.

More specifically, FIG. 8 shows an arrangement in which the outer grism 20 and the inner grism 30 are positioned in a “maximum additive disposition”. In such disposition, (a) the surfaces of the outer grism 20 and the inner grism 30 are fully aligned (in that their angled surfaces are aligned as much as possible) and (b) additive (meaning that deflection of the two grisms add to each other, as opposed to cancelling each other out. Accordingly, with the outer grism 20 providing a deflection of 16.45 degrees, for example, and the inner grism 30 providing a deflection of 16.45 degrees, the total deflection of the arrangement of FIG. 8 may be around 35 degrees, and not the pure addition result of 32.9 degrees, because the outer grism 20 operates in the beam-deviation space created by the operation of the inner grism 30.

FIG. 9 also shows an arrangement in which the outer grism 20 and the inner grism 30 are positioned in a “maximum additive disposition”. In such disposition, (a) the surfaces of the outer grism 20 and the inner grism 30 are fully aligned (in that their angled surfaces are aligned as much as possible) and (b) additive (meaning that deflection of the two grisms add to each other, as opposed to cancelling each other out. As compared to FIG. 8, the grisms 20, 30 of FIG. 9 are inverted as compared to FIG. 8. In similar manner to FIG. 8, the total deflection, i.e. bending of the light path, of the arrangement of FIG. 9 is 35 degrees. Accordingly, FIGS. 8 and 9 differ in that the grism pair have been rotated as a single unit by 180 deg.

FIG. 10 shows an arrangement in which the outer grism 20 and the inner grism 30 are positioned in a “maximum subtractive disposition”. In such disposition, (a) the surfaces of the outer grism 20 and the inner grism 30 are fully aligned (in that their angled surfaces are aligned as much as possible) and (b) subtractive (meaning that deflection of the two grisms cancel each other out. Accordingly, with the outer grism 20 providing a deflection of 16.45 degrees and the inner grism 30 providing a deflection of 16.45 degrees, the total deflection of the arrangement of FIG. 8 is 0 degrees, i.e. the two grisms cancel each other out, since the two grisms possess the same angle of deflection.

FIG. 11 also shows an arrangement in which the outer grism 20 and the inner grism 30 are positioned in a “maximum subtractive disposition”. In particular, FIG. 11 shows the grisms inverted as compared to FIG. 10. Accordingly, FIGS. 10 and 11 differ in that the grism pair have been rotated as a single unit by 180 deg.

Once a desired angle off the center steering axis 11 is attained, the grisms 20, 30 can be rotated as a unit—so as perform a “sweep” of the optical system 10 at a particular desired angle. In a polar sense, in terms of variables of r and theta (where r is the distance from a center steering axis and theta is the rotational angular position), the relative rotation of the grisms can be described as selecting the “r”, whereas the motion of the pair of grisms together can be described as selecting the “theta” angle.

In accordance with at least one embodiment of the disclosure, each of the outer grism 20 and the inner grism 30 can be provided with a respective support rotator, as is shown in FIG. 1. That is, the outer grism 20 can be provided with an outer support rotator 50. The inner grism 30 can be provided with an inner support rotator 60. The outer support rotator 50 and the inner support rotator 60 can be of similar construct.

The support rotator 50, i.e. the outer support rotator 50, can support the outer grism 20 and provide rotation to the outer grism 20, as controlled by a controller 120, in accordance with at least one embodiment of the disclosure. The controller 120 can include one or more computer processors and one or more databases. The controller 120 can include various applications or programs to enable the optical system to send and receive communications, including applications or programs to position the center steering axis 11 of the optical system 10, and to rotate the grism 20, 30 so as to adjust an external light path of either an incoming beam of light or an outgoing beam of light.

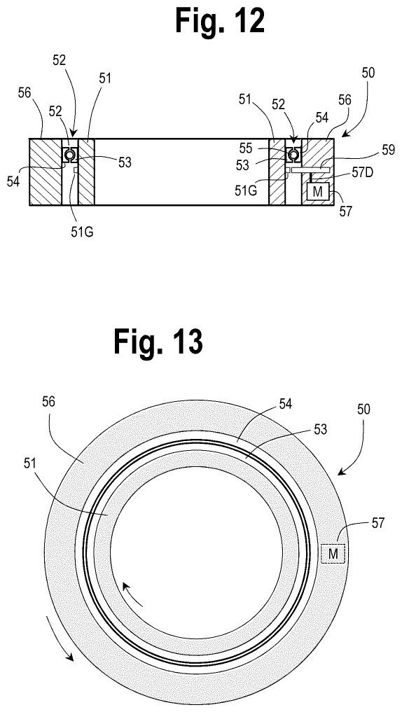

The outer support rotator 50 is shown in FIG. 3 and in FIGS. 12 and 13, for example. The outer support rotator 50 can include an inner collar 51. The inner collar 51 can include an inner surface that is attached to an outer surface of the grism-frame 27, so as to support the outer grism-frame assembly 28. Such attachment can be provided by brackets, other mechanical attachment mechanism, welding, recessed groove, or attachment in some other manner as desired.

The outer support rotator 50 can also include an outer collar 56. The outer collar 57 can be attached to and supported by a collar or joining collar 70, as shown in FIG. 3. In manner as described below, the joining collar 70 can be rotatably supported by a frame assembly 100. Further, the inner collar 51 and the outer collar 56 can be mechanically attached so as to be rotatable relative to each other, as described below. Mechanical attachment of the inner collar 51 and the outer collar 56, so as to be relatively rotatable, can be provided in any suitable manner. In accordance with at least one embodiment of the disclosure, mechanical attachment of the inner collar 51 and the outer collar 56 can be provided by a rotator rail assembly 52. The rotator rail assembly 52 can be positioned between the inner collar 51 and the outer collar 56.

As shown in FIG. 3 and FIGS. 12 and 13, the rotator rail assembly 52 can include an inner rail 53 that is mechanically attached to the inner collar 51. The rotator rail assembly 52 can also include an outer rail 54 that is mechanically attached to the outer collar 56. Both the inner rail 53 and the outer rail 54 can include a respective groove, which correspond to each other in an opposing manner. A plurality of ball bearings 55 can be provided in such groove, so that the inner rail 53 and the outer rail 54 are rotatably attached to each other. As result of such arrangement, the outer grism 20 is rotatably supported.

As shown in FIG. 3 and FIG. 12, a driver mechanism can be provided so as to drive the outer grism 20 within the outer collar 56. That is, the driver mechanism can include the motor 57. The motor 57 can be connected to a gear 59 by a drive linkage 57D, such that the motor can drive the gear 59.

Relatedly, the gear 59 can be in drivable engagement with inner collar 51. That is, the inner collar 51 (see FIG. 3) can include or be attached to a driven gear 51G. The driven gear 51G can be in the form of a concentric gear 51G that extends around the outer surface, i.e. the outer periphery, of the inner collar 51. Accordingly, the controller 120 can control the motor 57 to drive the gear 59—the gear 59 can drive the driven gear 51G so as to drive the outer grism-frame assembly 28. Accordingly, the controller 120 can drive the outer grism 20, so as to control the rotational position of the outer grism 20.

In similar manner to the outer grism 20, the inner grism 30 can be provided with a inner support rotator 60—such that the controller 120 can control rotation of the inner grism 30.

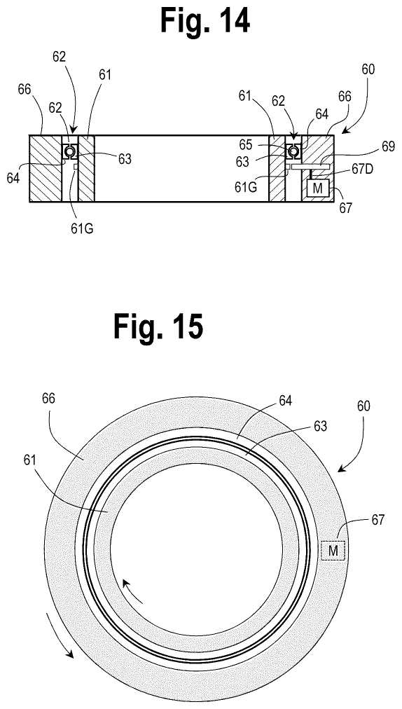

The inner support rotator 60 is shown in FIG. 3 and in FIGS. 14 and 15, for example. The inner support rotator 60 can include an inner collar 61. The inner collar 61 can include an inner surface that is attached to an outer surface of the grism-frame 37, so as to support the inner grism-frame assembly 38. Such attachment can be provided by brackets, other mechanical attachment mechanism, welding, recessed groove, or attachment in some other manner as desired.

The inner support rotator 60 can also include an outer collar 66. The outer collar 66 can be attached to and supported by a collar or joining collar 70, as shown in FIG. 3. In manner as described below, the joining collar 70 can be rotatably supported by a frame assembly 100.

Further, the inner collar 61 and the outer collar 66 can be mechanically attached so as to be rotatable relative to each other, as described below. Mechanical attachment of the inner collar 61 and the outer collar 66, so as to be relatively rotatable, can be provided in any suitable manner. In accordance with at least one embodiment of the disclosure, mechanical attachment of the inner collar 61 and the outer collar 66 can be provided by a rotator rail assembly 62. The rotator rail assembly 62 can be positioned between the inner collar 61 and the outer collar 66.

As shown in FIG. 3 and FIGS. 14 and 15, the rotator rail assembly 62 can include an inner rail 63 that is mechanically attached to the inner collar 61. The rotator rail assembly 62 can also include an outer rail 64 that is mechanically attached to the outer collar 66. Both the inner rail 63 and the outer rail 64 can include a respective groove, which corresponds to each other in an opposing manner. A plurality of ball bearings 65 can be provided in such groove, so that the inner rail 63 and the outer rail 64 are rotatably attached to each other. As result of such arrangement, the outer grism 30 is rotatably supported.

As shown in FIG. 3 and FIG. 14, a driver mechanism can be provided so as to drive the outer grism 30 within the outer collar 66. That is, the driver mechanism can include the motor 67. The motor 67 can be connected to a gear 69 by a drive linkage 67D, such that the motor can drive the gear 69.

Relatedly, the gear 69 can be in drivable engagement with inner collar 61. That is, the inner collar 61 (see FIG. 3) can include or be attached to a driven gear 61G. The driven gear 61G can be in the form of a concentric gear 61G that extends around the outer surface, i.e. the outer periphery, of the inner collar 61. Accordingly, the controller 120 can control the motor 67 to drive the gear 69—and the gear 69 can drive the driven gear 61G so as to drive the inner grism-frame assembly 38, which includes the outer inner grism 30. Accordingly, the controller 120 can drive the inner grism 30, so as to control the rotational position of the inner grism 30.

In accordance with at least one embodiment of the disclosed subject matter, as shown in FIG. 3, the outer grism 20 and the inner grism 30 (collectively a prism-grating pair 15, as shown in FIG. 3), i.e. a grism pair 15, can both be supported by a joining collar 70. The joining collar can be rotatably supported in or by a frame assembly 100 by an outboard support rotator 80, as described below. The controller 120 can control rotation of the joining collar 70, and as a result, control rotation of the grism pair 15. That is, the controller can control rotation of the outer grism 20 and the inner grism 30 as a unit, as described above.

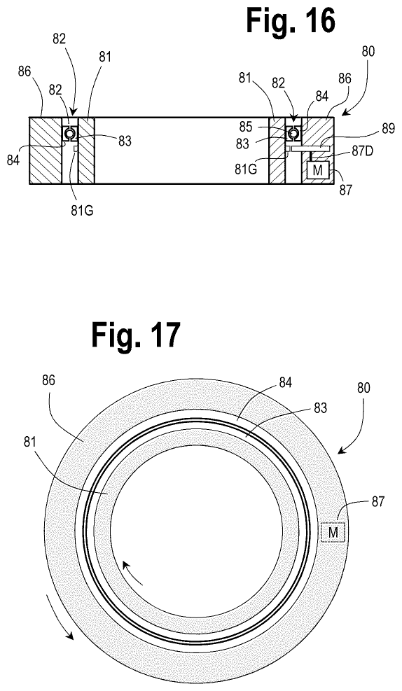

The outboard support rotator 80 is shown in FIG. 3 and in FIGS. 16 and 17, for example. The outboard support rotator 80 can include an inner collar 81. The inner collar 81 can include an inner surface that is attached to an outer surface of the joining collar 70, so as to support the joining collar 70. Such attachment can be provided by brackets, other mechanical attachment mechanism, welding, recessed groove, or attachment in some other manner as desired.

The outboard support rotator 80 can also include an outer collar 86. The outer collar 87 can be attached to and supported by a outboard cylindrical housing 101, as shown in FIG. 3. Accordingly, the joining collar 70 can be rotatably supported by a frame assembly 100.

Further, the inner collar 81 and the outer collar 86 can be mechanically attached so as to be rotatable relative to each other, as described below. Mechanical attachment of the inner collar 81 and the outer collar 86, so as to be relatively rotatable, can be provided in any suitable manner. In accordance with at least one embodiment of the disclosure, mechanical attachment of the inner collar 81 and the outer collar 86 can be provided by a rotator rail assembly 82. The rotator rail assembly 82 can be positioned between the inner collar 81 and the outer collar 86.

As shown in FIG. 3 and FIGS. 16 and 17, the rotator rail assembly 82 can include an inner rail 83 that is mechanically attached to the inner collar 81. The rotator rail assembly 82 can also include an outer rail 84 that is mechanically attached to the outer collar 86. Both the inner rail 83 and the outer rail 84 can include a respective groove, which corresponds to each other in an opposing manner. A plurality of ball bearings 85 can be provided in such groove, so that the inner rail 83 and the outer rail 84 are rotatably attached to each other. As result of such an arrangement, the joining collar 70 is rotatably supported.

As shown in FIG. 1 and FIGS. 16 and 17, a driver mechanism can be provided so as to drive the joining collar 70 within the outboard cylindrical housing 101. That is, the driver mechanism can include the motor 87. The motor 87 can be connected to a gear 89 by a drive linkage 87D, such that the motor can drive the gear 89.

Relatedly, the gear 89 can be in drivable engagement with inner collar 81. That is, the inner collar 81 (see FIG. 3) can include or be attached to a driven gear 81G. The driven gear 81G can be in the form of a concentric gear 81G that extends around the outer surface, i.e. the outer periphery, of the inner collar 81. Accordingly, the controller 120 can control the motor 87 to drive the gear 89—and the gear 89 can drive the driven gear 81G so as to drive the joining collar 70. Accordingly, the controller 120 can control the rotational position of the joining collar 70, within the outboard cylindrical housing 101.

The outboard cylindrical housing or first cylindrical housing 101 can be attached to and/or integrally formed with a second or inboard cylindrical housing 102 and/or to a housing base 103. The outboard cylindrical housing 101, the inboard cylindrical housing 102 and/or to a housing base 103 can be attached to a rotator rod 116 or other rotator structure 116. In turn, the rotator rod 116 or other rotator structure 116 can be attached to a 3-D rotator mechanism 115. The 3-D rotator mechanism 115 can be controlled by the controller 120, so as to control the angle and direction of disposition of the optical system 10, i.e. the angle and direction at which the optical system is directed. The controller 120 can include one or more computer processors and one or more databases. The databases can store data used by and/or generated by the computer processor of the controller.

The 3-D rotator mechanism 115 can be supported on a base 110. The base 110 can be supported on a support structure, such as a plane, ship, satellite, vehicle, ground structure or any other support structure as may be desired.

In some embodiments of the disclosure, the outboard cylindrical housing 101 and the inboard cylindrical housing 102 can be telescopically adjustable relative to each other, such as using a rack and pinion gear arrangement or in some other mechanical manner. Such telescopic arrangement allows a distance between the first grism 20 and the second grism to be adjusted, which may be helpful in some applications.

As described above, the optical system 10 can include an outer support rotator 50, an inner support rotator 60, and an outboard support rotator 80. Such rotators 50, 60, 80 can be driven and/or controlled by respective motors and/or other rotational mechanisms such as torquers and angular resolvers. Various components can be used such that the controller is able to control and “know” the respective positions of the rotators 50, 60, 80. Such components can include position encoders that provide feedback to the controller. The optical system 10 can include various mechanical support structure to support the various components. Such mechanical support structure can include various flanges, connectors, fasteners, and/or any known mechanical components or devices.

The outer support rotator 50, the inner support rotator 60, and the outboard support rotator 80 can be components of a rotational drive assembly 99, which can include a rotational drive mechanism. That is, a rotational drive assembly 99 of the optical system 10 can include the outer support rotator 50, the inner support rotator 60, and the outboard support rotator 80.

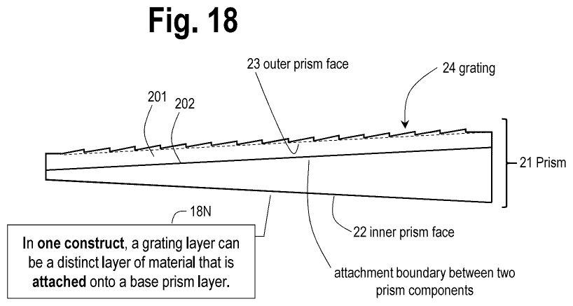

FIG. 18 is a schematic diagram of a further prism in accordance with at least one embodiment of the disclosure. As shown in FIG. 18 at 18N, in one construct of a prism of the disclosure, a grating layer 201 can be a distinct layer of material that is attached onto a base prism layer, along a grating layer interface 202. In general, FIG. 18 illustrates that a prism of the disclosure does not need to be one integral prism upon which a grating is etched. Rather, a prism of the disclosure might be multiple layers of material that are attached together, so as to provide the desired light deflection.

As described herein, the grating has been provided on an outer side of the prism, i.e. the side away from the light transceiver, for example. However, alternatively, it is appreciated that the grating may be provided on the inner side of the prism, i.e. the side of the prism that is closer to the transceiver. Further, one prism may include grating on the outer side and one prism may include grating on the inner side.

Hereinafter, further aspects of the disclosure will be described.

As described above, the optical system 10 of the disclosure can provide for rotation of a single prism or rotation of the prism pair together. The functional result of the rotation of a single prism or rotation of the prism pair together can generate a complete cone of angular deviation, based on an r (radius) and theta polar relationship.

It is appreciated that known hardware can be used to implement the systems of the disclosure. For example, such known hardware can include hardware for implementing rotational motion (bearings, torquers, resolvers), and various related mechanical structures including bushings, motors, gears, inductosyns, and other position sensing devices.

As described herein, individual grisms (such as grisms 20,30) may be rotated independently. Such independent rotation may be performed so as to adjust the “r”, i.e. radius value, of the directed light beam about a center steering axis. Further, the grisms 20 and 30 may be rotated as a pair, using a third rotation system, such as a rotator 80 as described above. Such rotation of the grisms 20,30 might be performed with the grisms 20,30 “locked” together, either mechanically or through coding. It may be beneficial to lock the grisms 20,30 together and rotate the pair as a unit, so as to maintain a constant r value, while varying the rotational theta value. That is, rotation of the pair as a unit may be desired so as to reduce complexities, both mechanically and coding wise, associated with individual rotation of the prisms while attempting to maintain a static relative disposition between the two grisms.

It is appreciated that there generally are small differences in the refractive indices of all optical and IR (infrared) materials, depending on the manufacturer and the processes employed. Knowledge of these precise variations in the material being used can lead to more precise design parameters and higher overall optical throughput efficiencies.

It is appreciated that laser communications transceiver hardware (typically, the data transmitter wavelength) can be different/offset slightly from the beacon receiver wavelength. This offset can be provided so as to avoid crosstalk.

Over very long distances, the required lead ahead angles can be provided between the transmit and receive channels, due to the finite speed of light and the relative motions involved. That is, one is always receiving from where the transmitter was, and always transmitting to where the receiver will be. Such lead-ahead angular adjustments can be made within the beam transceiver 90, for example.

In general, both prism and grating angular deviations are dependent on the incidence angle [the simple grating equation n*lambda=d*sin(theta) is for normal or perpendicular incidence angle, where sin(incidence angle)=0]. Thus, from the perspective of the transmitter, the outer grism exists within the angular deviation of the inner grism (and therefore has a different incidence angle from the inner grism). Therefore, two identical grisms may not have precisely identical deviations of the incident beam. Further, from the perspective of the receiver, the inner grism exists within the angular deviation of the outer grism.

It is appreciated that various embodiments are described herein. It is appreciated that a particular feature of a particular embodiment described herein might be utilized in other embodiments described herein, as desired.

The present invention provides an optical system comprising: a light transceiver having a steering axis associated with such light transceiver, wherein the light transceiver transmits and/or receives a first light beam along an external light path; a first beam-deviation optical element, which controls the external light path, including a first prism having a first diffraction grating thereon, and wherein the steering axis passes through the first beam-deviation optical element, the first prism and the first diffraction grating collectively providing a first grism, the first prism diffraction grating having a diffraction order in the first order ; and a second beam-deviation optical element, which also controls the external light path, including a second prism structure having a second diffraction grating thereon, wherein the steering axis passes through the second beam-deviation optical element, the second prism and the second diffraction grating collectively providing a second grism; the second prism diffraction grating also having a diffraction order in the first order; and a rotational drive assembly operable to provide rotation to at least one of the first beam-deviation optical element and the second beam-deviation optical element about the steering axis, and the rotation adjusting an angle of the external light path as compared with the steering axis.

The optical system of the present invention is ideally suited where the first light beam is within the 30-60 nm wavelength range. The optical system of the present invention is ideally suited where the first prism has a prism apex angle of 6.0 degrees +/−3.0 degrees; and the first grating has a grating apex angle of 0.5 degrees +/−0.3 degrees. Additionally, the optical system of the present invention is ideally suited where the first prism has a prism apex angle of 6.3 degrees +/−0.5 degrees; and the first grating has a grating apex angle of 0.47 degrees +/−0.1 degrees. The first grism and the second grism of the optical system of the present invention could be constructed of GaAs (Gallium Arsenide). The first grism and the second grism could have substantially the same construct, such that the first grism and the second grism are interchangeable.

Further, the optical system of the present invention could have the first beam-deviation optical element positioned between the second beam-deviation optical element and the light transceiver, OR the second beam-deviation optical element is positioned between the first beam-deviation optical element and the light transceiver. The optical system could have the first prism possessing a prism apex angle of 6.0 degrees +/−2 degrees; and the first grating possessing a grating apex angle of 0.5 degrees +/−0.2 degrees. The first diffraction grating is ideally positioned on a side of the first prism that opposes the light transceiver; the second diffraction grating is ideally positioned on a side of the second prism that opposes the light transceiver; and the first grism including a first crystal, and the second grism including a second crystal. Further, the optical system of the present invention can be designed where the first grism includes a plurality of facets, each of the facets having a facet width of 80 um (micrometers) +/−10 um; and each of the facets having a facet depth of 0.7 um (micrometers) +/−0.1 um. The optical system of the present invention further providing a broad spectral range of 30-90 nm (nanometers) in conjunction with providing a total deviation cone angle of 70 degrees which can achieve a maximum total angular line of sight error of less than 10 urads. The optical system could provide an angular deviation, for the external light path, of 0 to 1 radian (0 to 57.2 degrees).

The optical system of the present invention, further including a frame assembly, the frame assembly supporting the light transceiver, the first beam-deviation optical element, the second beam-deviation optical element, and the rotational drive assembly; and the frame assembly being supported by a base assembly, the base assembly include a 3-D rotator mechanism that is configured to adjust the angle and direction of the light transceiver, so as to adjust the angle and direction of the steering axis of the optical system. The optical system of the present invention where the light transceiver is configured to transmit the first light beam, and the light transceiver is configured to receive a second light beam. Further, the rotational drive assembly includes: a first support rotator to support the first beam-deviation optical element; and a second support rotator to support the second beam-deviation optical element. The rotational drive assembly could also include a third support rotator that supports the first beam-deviation optical element and the second beam-deviation optical element.

The various components of embodiments of the disclosure may be made from any of a variety of materials. The prisms, gratings and/or grisms described herein may be made from various materials including GaAs (Gallium Arsenide), Ge33As12Se55 (AMTIR-1), zinc sulfide, silicon, calcium fluoride, germanium, plastic, glass, and/or other materials as may be desired.

Components of the disclosure may be made of materials including, for example, stainless steel, plastic, plastic resin, nylon, metal, aluminum, composite material, foam, rubber, wood, and/or ceramic, for example, any material described in this disclosure and/or any other material as may be desired. For example, the systems(s) of this disclosure and the various components that make up the systems of the disclosure could be manufactured as extruded aluminum with regard to the metal components used in the system of the disclosure and/or from injection molding techniques with regard to the plastic components used in the system of the disclosure.

A variety of production techniques may be used to make the apparatuses as described herein. For example, suitable injection molding, other molding techniques, casting, injection casting and/or any other manufacturing techniques might be utilized. Also, the various components of the apparatuses may be integrally formed, as may be desired, in particular when using molding construction techniques. Also, the various components of the apparatuses may be formed in pieces and connected together in some manner, such as with welding.

As shown in the drawings, various holes are illustrated. As described herein, such holes can receive screws, bolts or other attachment mechanisms so as to attach a first component to a second component. However, it is appreciated that the particular positioning of such holes can be varied as desired, and the disclosure is not limited to the particular positioning illustrated in the attached drawings. Any suitable attachment mechanism, or position of such attachment mechanism, can be utilized so as to attach an/or connect the various components described herein.

The various apparatuses and components of the apparatuses, as described herein, may be provided in various sizes and/or dimensions, as desired.

It will be appreciated that features, elements and/or characteristics described with respect to one embodiment of the disclosure may be variously used and combined with other embodiments of the disclosure as may be desired.

In this disclosure, quotation marks, such as with “connection portion”, have been used to enhance readability and/or to parse out a term or phrase for clarity.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; and similar language.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right”, “forward”, “back”, “inner”, “outer”, “front”, “back” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references discussed in the above Background section are hereby incorporated by reference in their entirety. All documents referenced herein are hereby incorporated by reference in their entirety.

As described herein, in at least some embodiments of the system of the disclosure, various processes are described as being performed by one or more computer processors. Such one or more computer processors can, in conjunction with a database or other data storage mechanism, provide and/or constitute a “processing machine,” i.e. a tangibly embodied machine, in that such one or more computer processors can include various physical computing devices as otherwise described herein, various support structure to physically support the computing devices, other hardware, and other physical structure, for example. In embodiments, a processing machine of the disclosure can include one or more computer processors and one or more databases that are in communication with the one or more computer processors. A computer processor or processing machine of the disclosure can be part of a higher-level system or apparatus. As described herein, “tangibly embodied” means that one can physically touch the particular item.

As used herein, the term “computer processor” can be understood to include at least one processor that uses at least one memory. The at least one memory can store a set of instructions. The instructions may be either permanently or temporarily stored in the memory or memories of the processing machine or associated with the processing machine. The computer processor can execute the instructions that are stored in the memory or memories in order to process data, input data, output data, and perform related processing. The set of instructions may include various instructions that perform a particular task or tasks, such as any of the processing as described herein. Such a set of instructions for performing a particular task may be described as a program, software program, code or simply software. Accordingly, various processing is described herein as performed by a computer processor (CP). Such computer processor (CP) can be described as or can include: a computer processor portion, a computer processing portion, a processor, a system processor, a processing system, a server, a server processing portion, an engine, a processing engine, a central processing unit (CPU), a controller, a processor-based controller, an electronic computing device, an apparatus controller, an apparatus computer processor, a processing device, a computer operating system, an apparatus processing portion, an apparatus processing portion, an electronic control unit (“ECU”), a microcontroller, a microcomputer, a plurality of electronic computing devices or servers, other processor-based controller(s), and/or similar constructs, for example.

A computer processor and/or processing machine, of the disclosure, may be constituted by and/or be part of particular apparatus(es), system(s) and/or device(s) described herein. The computer processor can execute instructions that are stored in memory or memories to process data. This processing of data may be in response to commands by a user or users of the computer processor, in response to previous processing, in response to a request by another processing machine and/or any other input, for example. A user can be in the form of a user device, such as a cellular phone.

A computer processor and/or processing machine of the disclosure may also utilize (or be in the form of) any of a wide variety of technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that can be capable of implementing the steps of the processes of the disclosure.

The computer processor and/or processing machine used to implement the disclosure may utilize a suitable operating system. Thus, embodiments of the disclosure may include a processing machine running the Windows 11 operating system, the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the disclosure as described herein, it is not necessary that the computer processors and/or the memories of a processing machine be physically located in the same geographical place. That is, each of the computer processors and the memories used by the processing machine may be located in geographically distinct locations and connected so as to communicate in any suitable manner. Additionally, it is appreciated that each computer processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected and in communication with each other in any suitable manner. Additionally, the memory may include two or more portions of memory in two or more physical locations.

To explain further, processing as described above can be performed by various processing components and various memories. However, it is appreciated that the processing performed by two distinct components as described herein may, in accordance with a further embodiment of the disclosure, be performed by a single component. Further, the processing performed by one distinct component as described above may be performed by two distinct components. For example, processing as described herein might be performed in part by a system or other system or server, in part by some third-party resource, and in part by a user device. In a similar manner, the memory storage performed by two distinct memory portions as described herein may, in accordance with a further embodiment of the disclosure, be performed by a single memory portion. Further, the memory storage performed by one distinct memory portion as described above may be performed by two memory portions.

Further, as described herein, various technologies may be used to provide communication between the various processors and/or memories, as well as to allow the processors and/or the memories of the disclosure to communicate with any other entity; i.e., so as to obtain further instructions, transfer data, or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described herein, a set of instructions can be used in the processing of the disclosure on the processing machine, for example. The set of instructions may be in the form of a program or software to perform the processing as described herein. The software may be in the form of system software or application software, for example. The software might also be in the form of a collection of separate programs, a program module within a larger program, or a portion of a

program module, for example. The software used might also include modular programming in the form of object-oriented programming. The software tells the processing machine what to do with the data being processed.

It is appreciated that the instructions or set of instructions used in the implementation and operation of features of the disclosure may be in a suitable form such that a computer processor or processing machine may read the instructions. For example, the instructions that form a program may be in the form of a suitable programming language, which can be converted to machine language or object code to allow the processor or processors to read the instructions. That is, written lines of programming code or source code, in a particular programming language, can be converted to machine language using a compiler, assembler or interpreter. The machine language can be binary coded machine instructions that are specific to a particular type of processing machine, i.e., to a particular type of computer processor, for example. The computer processor understands the machine language.

Accordingly, a suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, Python, Ruby, PHP, Perl, JavaScript, and/or other scripting language, for example. Further, it is not necessary that a single type of instructions or single programming language be utilized in conjunction with the operation of the systems and methods of the disclosure. Rather, any number of different programming languages may be utilized as may be necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example. Accordingly, a compression or encryption technique or algorithm can be used that transforms the data from an un-encrypted format to an encrypted format.

As described above, the disclosure may illustratively be embodied in the form of a processing machine, including a computer processor, for example, that includes at least one memory. It is to be appreciated that the set of instructions, i.e., the software for example, that enables the computer processor to perform the operations described herein may be contained on any of a wide variety of media or medium, as desired. Further, the data that can be processed by the set of instructions can be contained on any of a wide variety of media or medium. That is, the particular medium, i.e., the memory or data storage device used in a processing machine, utilized to hold the set of instructions and/or the data used in practice of the disclosure may take on any of a variety of physical forms or transmissions, for example. Illustratively, the medium or data storage device may be in a tangibly embodied form of paper, paper transparencies, a compact disk, a DVD, an integrated circuit, a hard disk, a floppy disk, an optical disk, a magnetic tape, a RAM, a ROM, a PROM, a EPROM, a CD-ROM, a DVD-ROM, a hard drive, a magnetic tape cassette, a wire, a cable, a fiber, communications channel, and/or may be in the form of a satellite transmissions or other remote transmission, as well as any other medium or source of data that may be read by the processors of the disclosure.

For example, exemplary embodiments are intended to cover all software or computer programs capable of enabling processors to implement the operations, designs and determinations as described herein. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed herein.

These computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs and outputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. A network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The database(s), memory or memories used in the processing machine that implements the disclosure may be in any of a wide variety of forms to allow the memory to hold instructions, data, or other information, as can be desired. Thus, a memory might be in the form of a database to hold data. The database might use any desired arrangement of files or data sets such as a flat file arrangement or a relational database arrangement, for example. The database can include any number of data records, tables, and/or other data structures. A table in a database can include a Primary key (PK) to identify the table. A foreign key (FK) can be an attribute in one table (entity) that links or maps to the PK of another table, so as to provide an interrelationship or mapping between tables and/or databases, for example.

In various processing described herein and illustrated by flowcharts or otherwise described, variables can be used in various processes. Such processes can include routines, subroutines, and steps, for example. The various variables can be passed between processes as may be needed in accord with the instructions provided to a processor. The various variables can be global variables that are available to all the various processes, such as between a calling process and a subroutine, for example.

In the system and method of the disclosure, a variety of “user interfaces” may be utilized to allow a user to interface with the processing machine or machines that are used to implement the disclosure. As used herein, a user interface can include any hardware, software, or combination of hardware and software used by the processing machine that allows a user to interact with the processing machine and/or computer processor. A user interface may be in the form of a dialogue screen for example. A user interface may also include any of a mouse, touch screen, keyboard, voice reader, voice recognizer, dialogue screen, menu box, list, checkbox, toggle switch, a light, a pushbutton or any other device that allows a user to receive information regarding the operation of the processing machine as the processing machine processes a set of instructions and/or provide the processing machine with information. Accordingly, the user interface can be any device that provides communication between a user and a processing machine and/or computer processor. The information provided by the user to the processing machine through the user interface may be in the form of a command, a selection of data, or some other input, for example.

A user interface of the disclosure can be provided by or in the form of a user device or electronic user device. Also, systems of the disclosure can include or be in communication with one or more user devices that serve to interact or interface with a human user. A user device can be any appropriate electronic device, such as a cellular (mobile) telephone, smart phone, a tablet computer, a laptop computer, a desktop computer, an e-reader, an electronic wearable, smartwatch, gaming console, personal digital assistant (PDA), portable music player, fitness trackers with smart capabilities, and/or a server terminal, for example.

Such a user device can permit a user to input requests for information, output information, and/or process data. A user device can be in the form of and/or include a computer processor and/or a processing machine, as described herein.

As discussed above, a user interface can be utilized by the processing machine, which performs a set of instructions, such that the processing machine processes data for a user. The user interface can be typically used by the processing machine for interacting with a user either to convey information or receive information from the user. However, it should be appreciated that in accordance with some embodiments of the systems and methods of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be described as a user. Further, it is contemplated that a user interface utilized in the systems and methods of the disclosure may interact partially with another processing machine or processing machines, while also interacting partially with a human user.

As used herein, “data” and “information” have been used interchangeably.

In conclusion, it will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. An optical system comprising:
a light transceiver having a steering axis associated with such light transceiver, wherein the light transceiver transmits and/or receives a first light beam along an external light path;
a first beam-deviation optical element, which controls the external light path, including a first prism having a first diffraction grating thereon, and wherein the steering axis passes through the first beam-deviation optical element, the first prism and the first diffraction grating collectively providing a first grism,
the first prism diffraction grating having a diffraction order in the first order ; and
a second beam-deviation optical element, which also controls the external light path, including a second prism structure having a second diffraction grating thereon, wherein the steering axis passes through the second beam-deviation optical element, the second prism and the second diffraction grating collectively providing a second grism;
the second prism diffraction grating also having a diffraction order in the first order; and
a rotational drive assembly operable to provide rotation to at least one of the first beam-deviation optical element and the second beam-deviation optical element about the steering axis, and
the rotation adjusting an angle of the external light path as compared with the steering axis.

2. The optical system of claim 1, wherein the first light beam is within the 30-60 nm wavelength range.

3. The optical system of claim 1,
the first prism possessing a prism apex angle of 6.0 degrees +/−3.0 degrees; and
the first grating possessing a grating apex angle of 0.5 degrees +/−0.3 degrees.

4. The optical system of claim 1,
the first prism possessing a prism apex angle of 6.3 degrees +/−0.5 degrees; and
the first grating possessing a grating apex angle of 0.47 degrees +/−0.1 degrees.

5. The optical system of claim 1, the first grism is constructed of GaAs (Gallium Arsenide); and the second grism is also constructed of GaAs.

6. The optical system of claim 1, the first grism and the second grism having substantially the same construct, such that the first grism and the second grism are interchangeable.

7. The optical system of claim 6,
the first beam-deviation optical element is positioned between the second beam-deviation optical element and the light transceiver, OR
the second beam-deviation optical element is positioned between the first beam-deviation optical element and the light transceiver.

8. The optical system of claim 1,
the first prism possessing a prism apex angle of 6.0 degrees +/−2 degrees; and
the first grating possessing a grating apex angle of 0.5 degrees +/−0.2 degrees.

9. The optical system of claim 1,
the first diffraction grating positioned on a side of the first prism that opposes the light transceiver;
the second diffraction grating positioned on a side of the second prism that opposes the light transceiver; and
the first grism including a first crystal, and the second grism including a second crystal.

10. The optical system of claim 1, the first grism including a plurality of facets,
each of the facets having a facet width of 80 um (micrometers) +/−10 um; and
each of the facets having a facet depth of 0.7 um (micrometers) +/−0.1 um.

11. The optical system of claim 1, the optical system providing a broad spectral range of 30-90 nm (nanometers) in conjunction with providing a total deviation cone angle of 70 degrees.

12. The optical system of claim 11, the optical system providing a maximum line of sight error of less than 10 urads.

13. The optical system of claim 1, further including a frame assembly, the frame assembly supporting the light transceiver, the first beam-deviation optical element, the second beam-deviation optical element, and the rotational drive assembly; and
the frame assembly being supported by a base assembly, the base assembly include a 3-D rotator mechanism that is configured to adjust the angle and direction of the light transceiver, so as to adjust the angle and direction of the steering axis of the optical system.

14. The optical system of claim 1, the light transceiver is configured to transmit the first light beam, and
the light transceiver is configured to receive a second light beam.

15. The optical system of claim 1, the rotational drive assembly includes:
a first support rotator to support the first beam-deviation optical element; and
a second support rotator to support the second beam-deviation optical element.

16. The optical system of claim 15, the rotational drive assembly further includes:
a third support rotator that supports the first beam-deviation optical element and the second beam-deviation optical element.
